(19) United States
(12) Patent Application Publication
(10) Pub. No.: US 2007/0200018 A1
(43) Pub. Date: Aug. 30, 2007

(54) Food processing apparatus

(76) Inventors: Chi Wah Leung, Hong Kong (HK); Chi Chung Fung, Hong Kong (HK); Shek Chuen Luk, Hong Kong (HK)

Correspondence Address: OSTROLENK FABER GERB & SOFFEN, 1180 AVENUE OF THE AMERICAS, NEW YORK, NY, 100368403, US

(21) Appl. No.: 11/362,638

(22) Filed: Feb. 27, 2006

(51) Int. Cl. B02C 18/00

(52) U.S. Cl. 241/199.12; 241/282.1

(57) ABSTRACT

A food mixing apparatus comprising a container defining a cavity and adapted to contain food to be treated, a first blade member rotatable to mix and/or cut food in said container, and a second blade member rotatable to remove food adhered on a sidewall of the container in the cavity in the container.

### FIELD OF THE INVENTION

The present invention relates to an apparatus for processing food such as chopping, blending and/or mixing food, and in particular an electric food processing apparatus such as a food processor, a food chopper or a food blender.

### BACKGROUND OF THE INVENTION

There are a variety of conventional food-processing apparatus in the market. One type of food processing apparatus is commonly called “food processor” in which food to be treated may be chopped and mixed in a container provided with the processor. While this type of food processor is effective to a certain extent to chop food, one common problem is that it often does not blend and mix the food efficiently and evenly enough. For instance, when a conventional food processor is used for chopping carrot, the processed carrot will often be uneven and contain larger carrot fragments mixed with smaller carrot fragments. The problem is particularly more noticeable and prominent when different foodstuffs are being treated at the same time, apparently due to different characteristics of the foodstuffs to be treated.

The present invention seeks to address at least this problem, or to provide an alternative to the public.

### SUMMARY OF THE INVENTION

According to a first aspect of the present invention, there is provided with a food processing apparatus comprising a container defining a cavity and adapted to contain food to be treated, a first blade member rotatable to mix and/or cut food in the container, and a second blade member rotatable to remove food adhered on a sidewall in the container. The provision of the rotatable second blade member may direct foodstuff adhered on the sidewall to the first blade member in order that the foodstuff may be mixed and/or cut more efficiently and evenly.

Preferably, the container may have a transverse cross section in circular shape. One advantage of providing the container with such a shape is that the second blade member can remove the foodstuff adhered on the sidewall adhered on the sidewall in a relatively simple and rotating manner.

Suitably, the first blade member and the second blade member may be fixedly connected together. With this arrangement, the blade members are provided in one component. Alternatively, the blade members may be releasably connected together. With this alternative arrangement, the blade members may be separated when not in use for, for example, easier cleaning.

Advantageously, the second blade member may be relatively thin and/or elongate in shape. A blade member having such characteristics necessarily has a relatively smaller surface area which discourages foodstuff to adhere thereon. Further, a thinner blade may operate more effectively when removing foodstuff adhered on the sidewall than for example a thicker blade. The second blade member may also be relatively narrow such that interference of the mixing or cutting of the food in the container may be minimized.

Preferably, the second blade member may be arranged vertically adjacent the sidewall and adapted to direct foodstuff adhered thereon to the first blade member, such that the food may be blended more efficiently and mixed more evenly. In one embodiment, the second blade member may abut the sidewall while rotating in the container.

Suitably, there may be provided with two (or at least two) of the second blade members arranged on opposite sides in the container. The provision of two of the second blade members may be more efficient in assisting the first blade member in mixing or chopping the food than providing just one second blade member. Further, with the two second members, the rotation thereof in the container may be more balanced.

Advantageously, the second blade member may be manually operable. With this arrangement, the second blade member is being operated only when a user would like to remove foodstuff adhered on the sidewall in the container. For example, the second blade member may be operable by a rotatable handle or knob. Alternatively, the second blade member may be electrically operated. With this alternative arrangement, the operation of the second blade manner may be put to work on press of a button.

Preferably, the apparatus may be provided with a base member arranged at the bottom in the container and connected to the lower end of the second blade member. In particular, the base member may be sufficiently thick and/or, for safety reason, adapted to prevent access to the cutting edge of the first blade member from below or from opposite sides thereof.

Suitably, both the first blade member and the second blade member may be rotatable simultaneously. With this arrangement, in use food to be treated may always be directing to the first blade member. Alternatively, both the first blade member and the second blade member may be rotatable independently. In one embodiment, the first blade member may rotate in a clockwise direction and the second blade member may rotate in a counter-clockwise direction.

The above-described apparatus may be a food processor, a food chopper or a food blender.

### BRIEF DESCRIPTION OF DRAWINGS

Some embodiments of the present invention will now be described by way of example and with reference to the accompanying drawings, in which:—

FIG. 1 shows a perspective view of a first embodiment of a container of a food processor in accordance with the present invention,

FIG. 2 shows a cross section view of the container of FIG. 1 taken along line A-A′ in FIG. 1,

FIG. 3 shows another cross section view of the container of FIG. 1 taken at line B-B′ in FIG. 1,

FIG. 4 shows a perspective view of the container of FIG. 1 but in a different configuration,

FIG. 5 shows a side view of the container of FIG. 4,

FIG. 6 shows a cross section view of the container of FIG. 4 taken at line C-C′,

FIG. 7 shows a top view of the container of FIG. 4,

FIG. 8 shows an exploded view of the container of FIG. 1,

FIG. 9 shows a perspective view of a second embodiment of a container of a food processor in accordance with the present invention,

FIG. 10 shows another perspective view of the container of FIG. 9,

FIG. 11 shows a side view of the container of FIG. 9,

FIGS. 12a to 12d show top views of the container of FIG. 9 and cross sectional lines D-D′, E-E′, F-F′, G-G′ and H-H′,

FIGS. 13 to 17 show different cross section views of the container of FIG. 9 taken at lines D-D′, E-E′, F-F′, G-G′ and H-H′, respectively, and

FIG. 18 shows an exploded view of the container of FIG. 9.

### DETAILED DESCRIPTION OF PREFERRED EMBODIMENTS

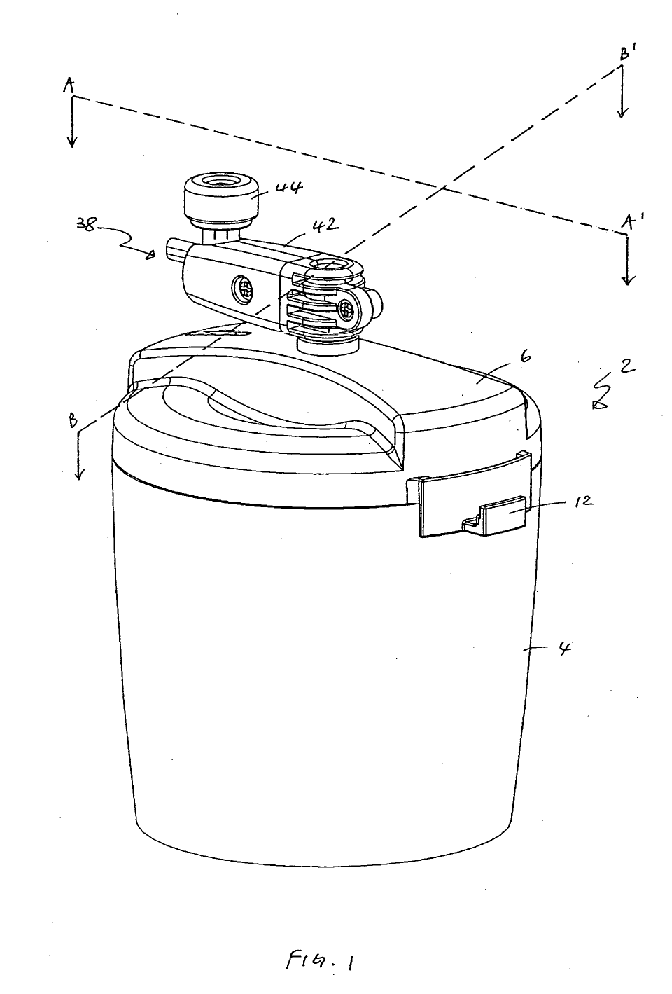

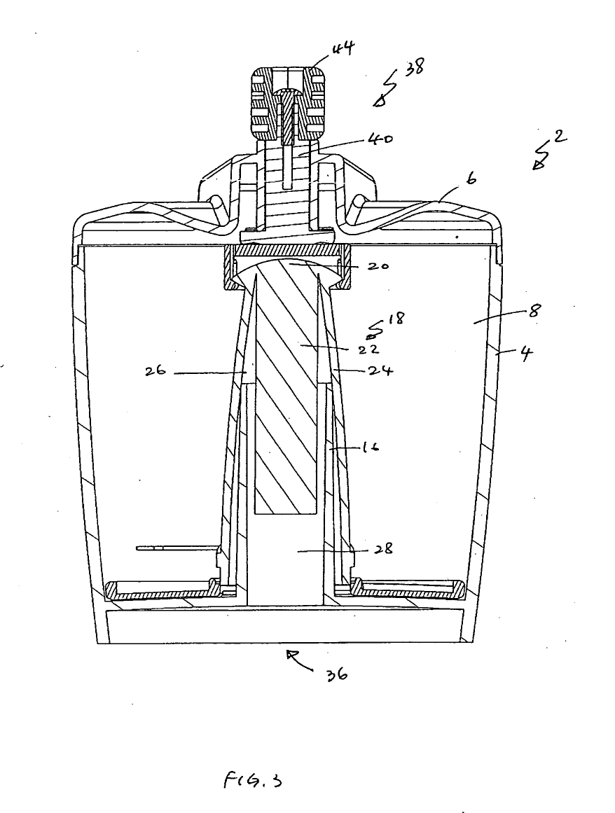

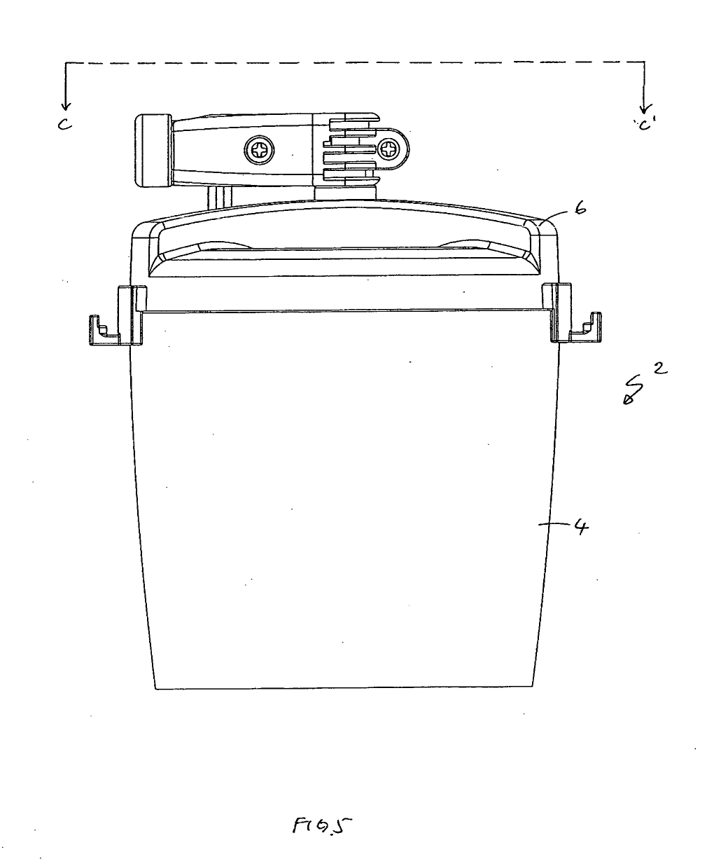

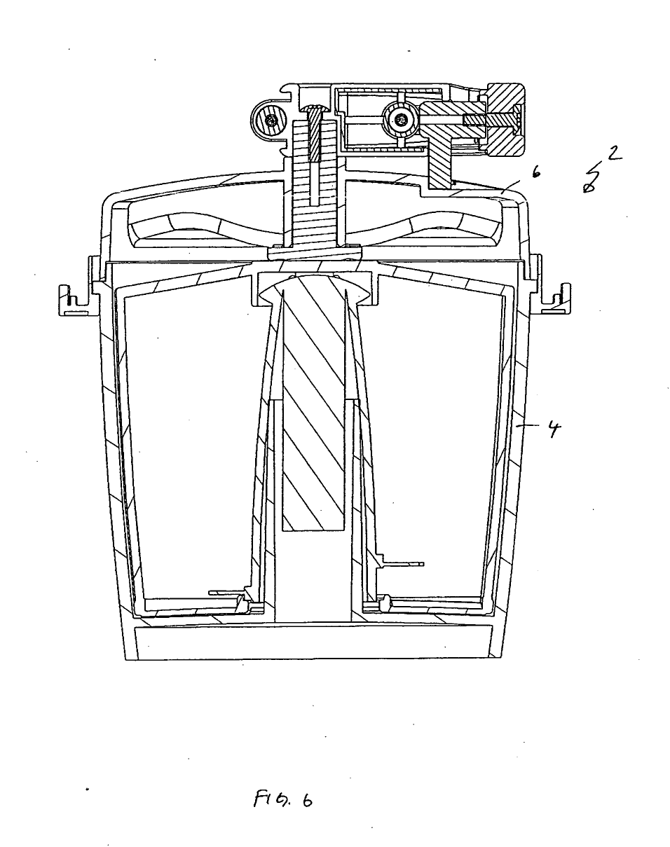

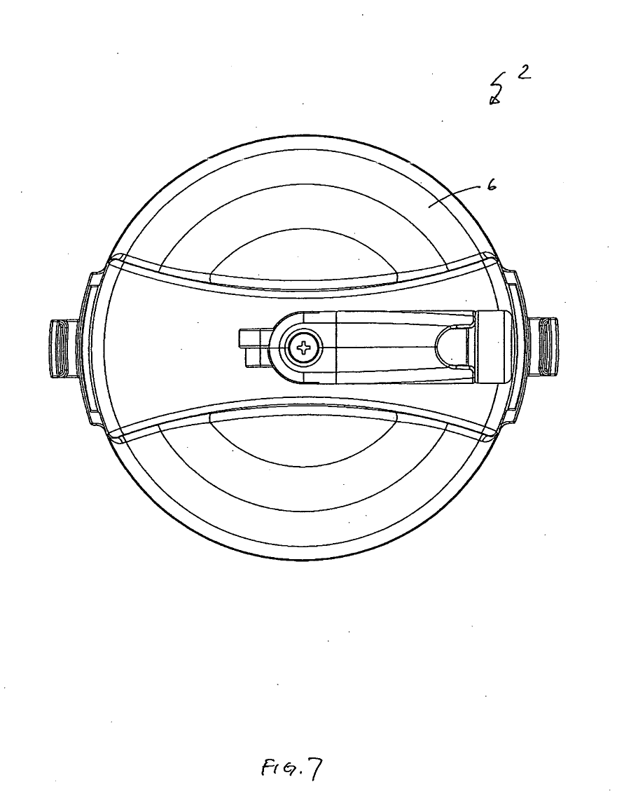

Referring firstly to FIGS. 1 to 8 there is shown a first embodiment of a container 2 of a food processor in accordance with the present invention. The food processor is provided with a main body 4 and a lid 6 releasably fitted thereon.

As shown in FIGS. 1 to 3 and 8, the body 4 and the lid 6 together define a cavity 8 for containing food to be processed. The body 4 of the container 2 has an upper opening 10 through which food may be deposited in the cavity 8. The body 4 has a transparent housing such that a user can observe the status of the food being processed. The container 2 is also provided with a pair of handles 12, 14 adjacent to the opening 10 and on opposite sides of the body 4.

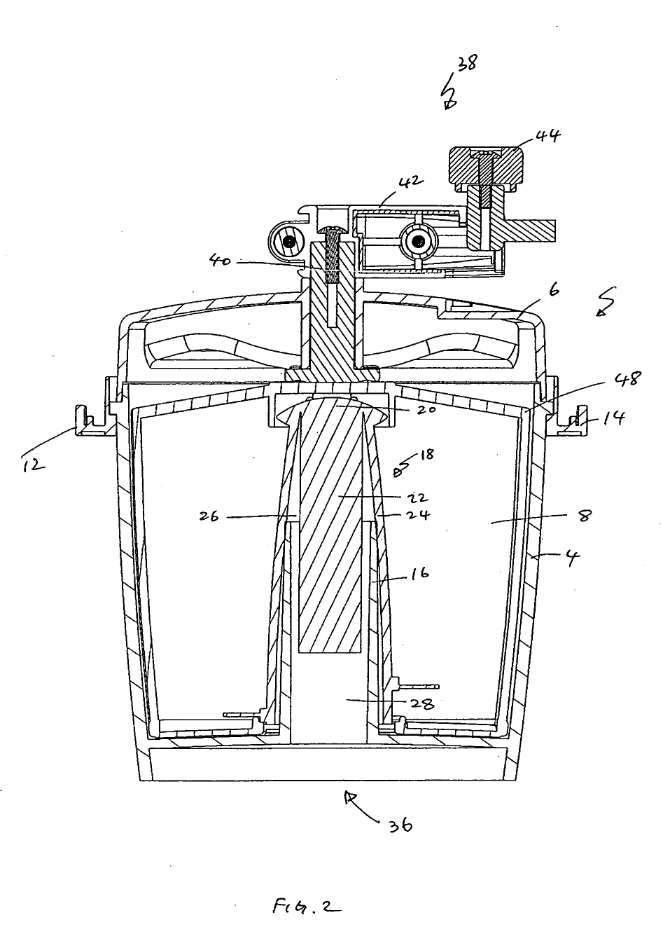

As shown in FIGS. 2, 3 and 8, the body 4 is provided with a tubular member 16 in the center and upwardly extending from the bottom to approximately mid-way in the container 2. The container 2 is also provided with a first blade means 18 having an enlarged circular head portion 20 arranged near the opening 10. A cylindrical elongate member 22 is downwardly extending from the center region of the head portion 20, and an elongate skirt 24 depends from an outer region of the head portion 20 and surrounds the elongate member 22. The skirt 24 is substantially longer than the elongate member 22 and is comparable in height with the body 4 of the container 2. A circumferential gap 26 is defined between the skirt 24 and the elongate member 22, and a cavity in the form of a recess 28 is provided at the lower end of the first blade means 18. The lower end of the skirt 24 is provided with a pair of steel blade members 30, 32 with sharp cutting edges laterally extending from opposite sides thereof. The skirt 24 and the elongate member 22 are sized and shaped such that the upwardly extending tubular member 16 is releasably received in the gap 26 therebetween via a lower opening 34 of the skirt. The main body 4 of the food processor (not shown) is provided with a coupler upwardly extending from a conventional stand thereof and the lower end of the tubular member 16 is provided with an opening 36 sized and shaped to receive the coupler when the container 2 sits on the stand at the coupler. As the container 2 sits on the stand of the food processor with the first blade means 18 assembled in the container 2, the coupler via the tubular member 16 engages the elongate member 22 of the first blade means 18 which is drivenable to rotate in use.

As shown in FIGS. 1, 2, 3 and 8, the lid 6 of the container 2 is provided with a rotatable handle 38 having a spindle portion 40 extending vertically therethrough, a horizontally disposed arm portion 42 and a rotatable knob portion 44. The lower end of the spindle portion 40 is provided with a cam means 46 engageable with and for rotating a second blade means 48. The second blade means 48 has a cap member 50 on which a number of gear members 52 are provided. The cam means 46 is engageable with and is provided to drive the gear members 52. Two ribs 54, 56 are laterally extending from opposite sides of the cap member 50, and two thin and elongate blade members 58, 60 depend from opposite sides of the ribs 54, 56. A circular base member 62 having an outer ring 64 and an inner ring 66 is arranged at the bottom of the container 2. The outer and inner rings 64, 66 are connected together with a number of radially extending ribs 68, 70, 72, 74. The outer ring 64 of the base member 62 is connected to the lower end of the elongate members 58, 60. The elongate members 58, 60 have a thinner side 76 and a thicker side 78. When the removable second blade means 48 is assembled and installed in the container 2, the elongate members 58, 60 are arranged adjacent to the sidewall of the container 2, with the thinner side 76 arranged very close to or abut the sidewall.

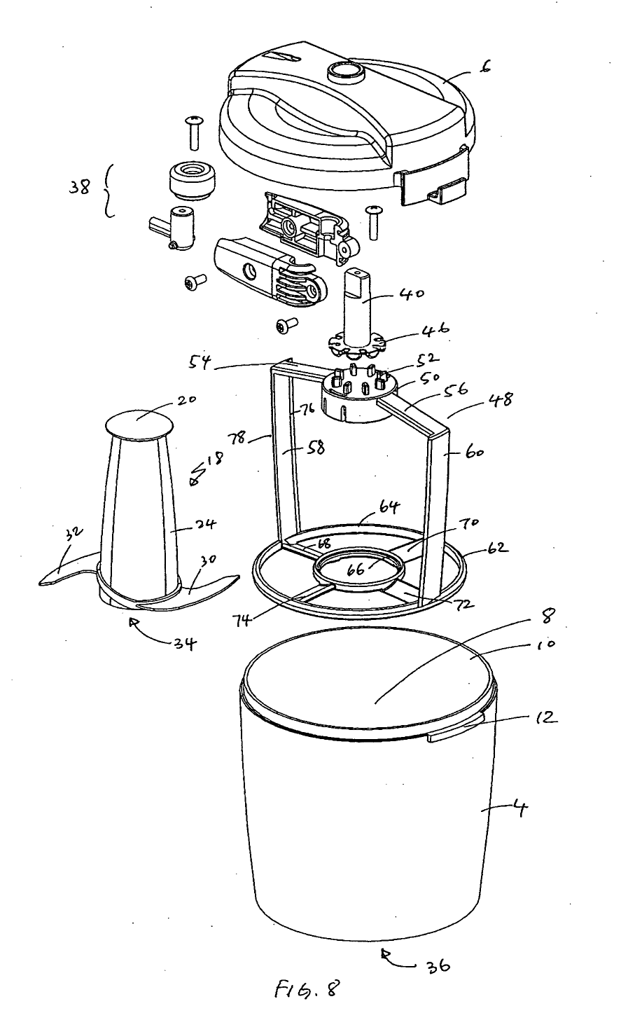

In use, when the various parts as shown in FIG. 8 are assembled together and become the container 2 as shown in FIGS. 1, 2 and 3, the container 2 is ready to receive food for processing. It is envisaged that during operation the first blade means 18 is driven by the coupler and is caused to rotate in high speed. However, as food contained in the container 2 is being chopped into smaller pieces by the rotating blade members 30, 32, some foodstuff may be viscous or sticky and may be swung to adhere on the sidewall in the container. This is undesirable because this foodstuff may not yet be chopped by the blade members 30, 32, and in any case it may not have been evenly mixed with the rest of the food in the container 2. In such circumstances, a user observing this can then rotate the rotatable handle 38. This will cause the second blade means 48 to rotate and scrap off the foodstuff from the sidewall and direct it to the center in the container 2 for processing by the rotating blade members 30, 32.

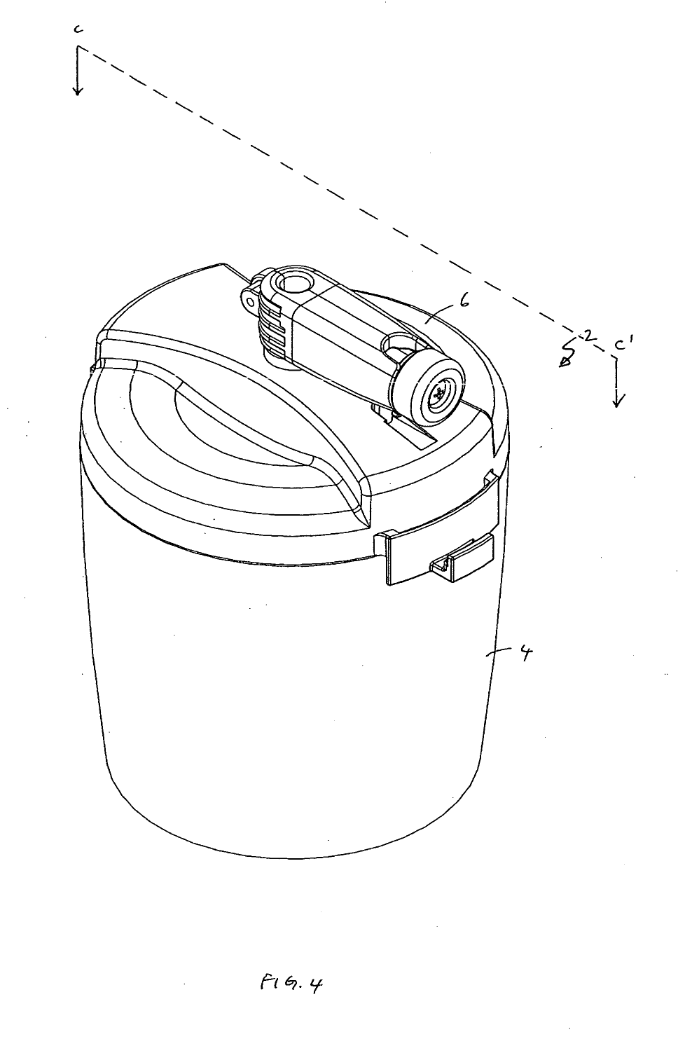

After using the food processor, the first blade means 18 and the second blade means 48 are removable from the container 2 for cleaning. In this embodiment, both the first blade means 18 and the second blade means 48 are separate components and detachable from the container 2. It is to be noted that the rotatable knob 44 of the handle 38 is movable between an upstanding configuration (see FIGS. 1 to 3) in which a user can rotate the second blade means 48 by holding onto the knob and move it in a circular path such that the thinner side of the elongate members 58, 60 can scrap off the foodstuff as it rotates and a stowed configuration (see FIGS. 4 to 7) in which the knob is turned downward. The provision of such a handle 38 can reduce the height of the container 2 for ease of storage.

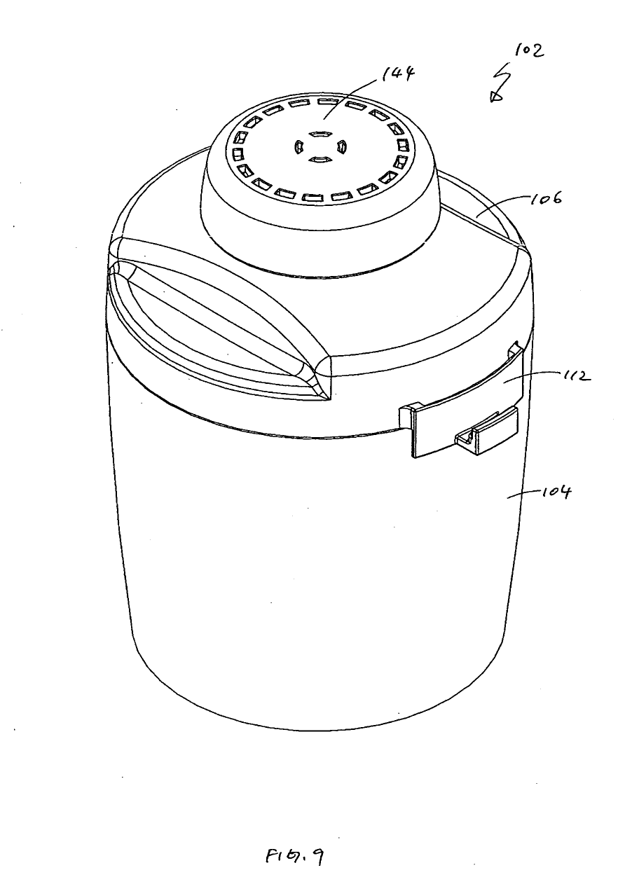

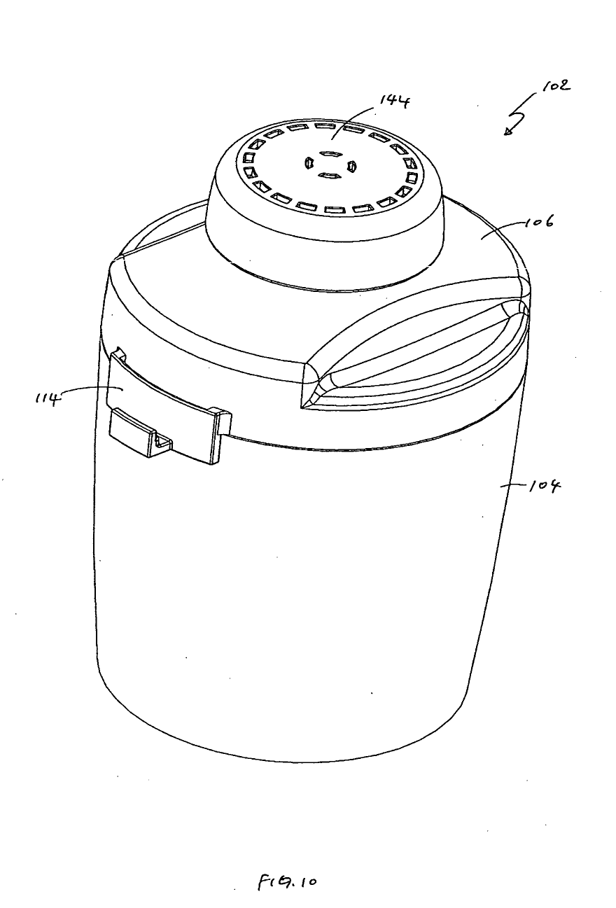

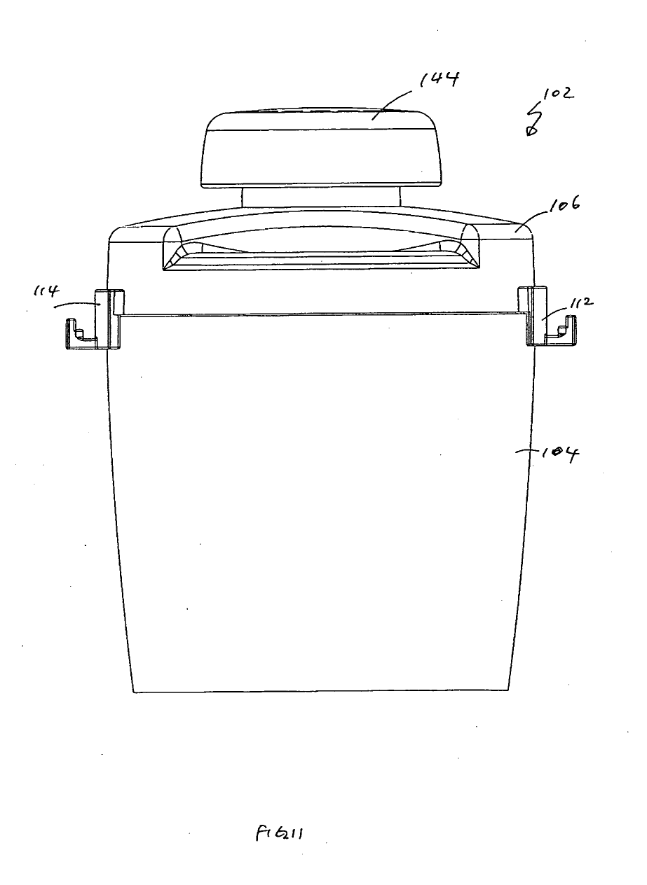

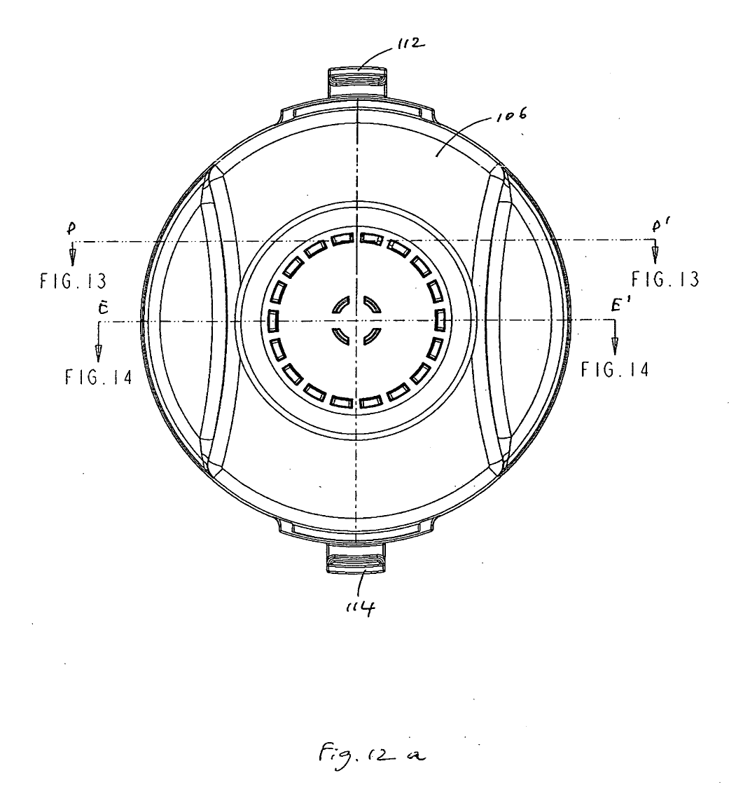

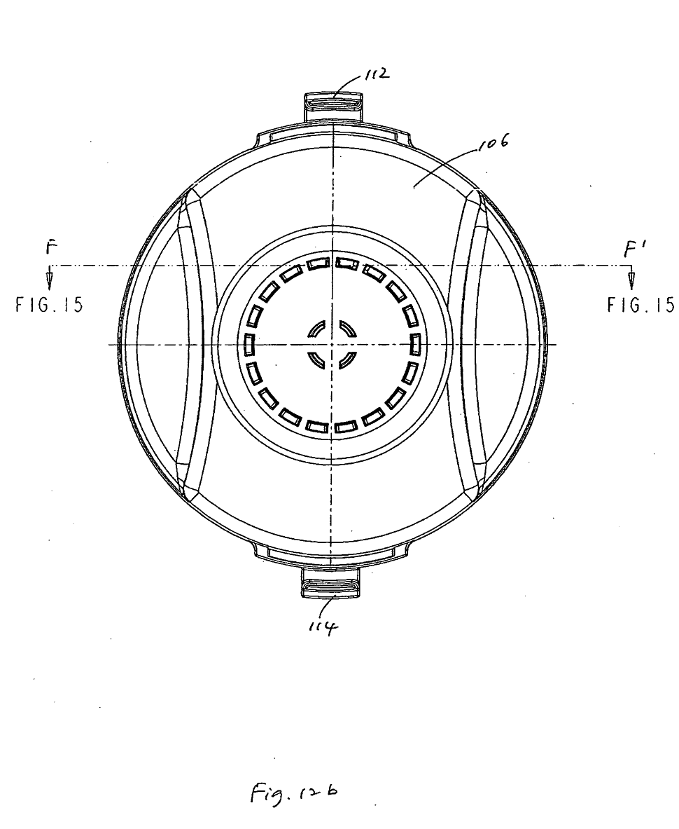

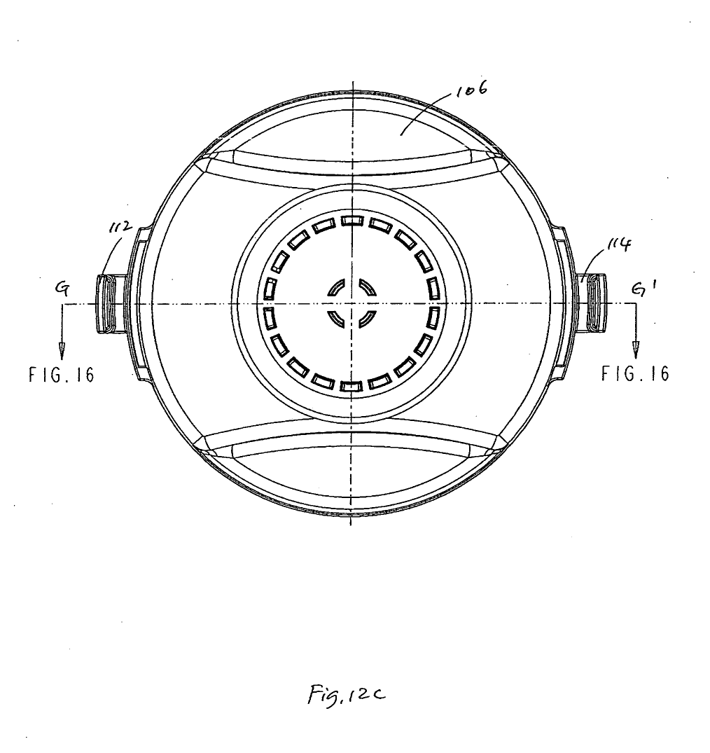

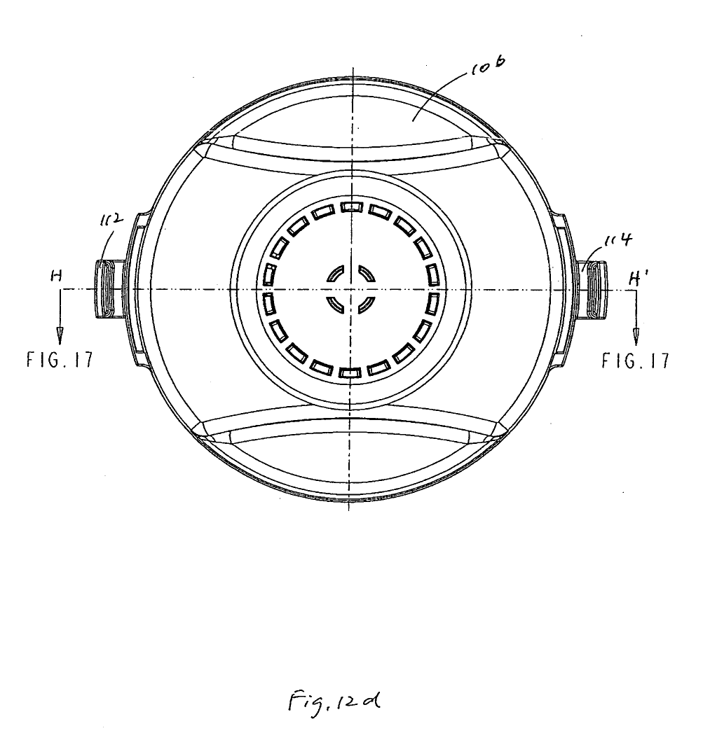

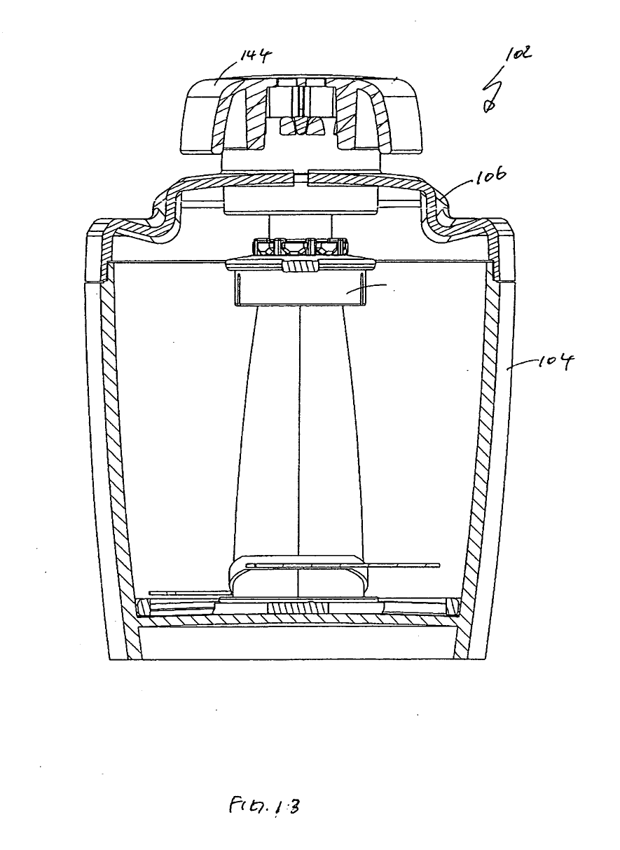

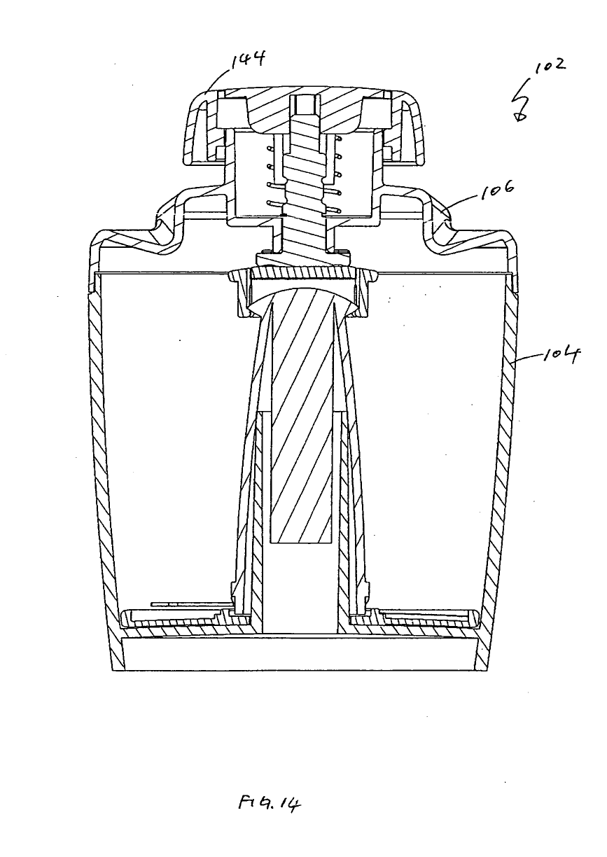

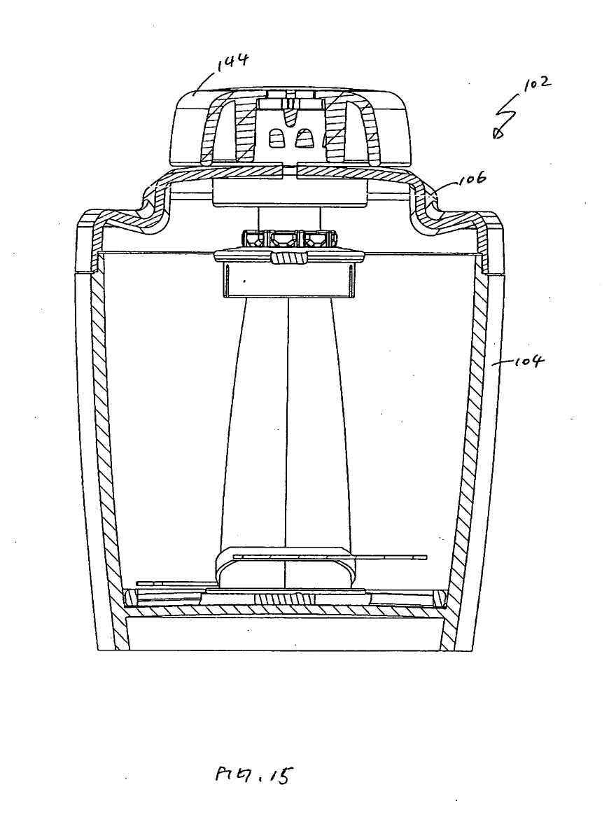

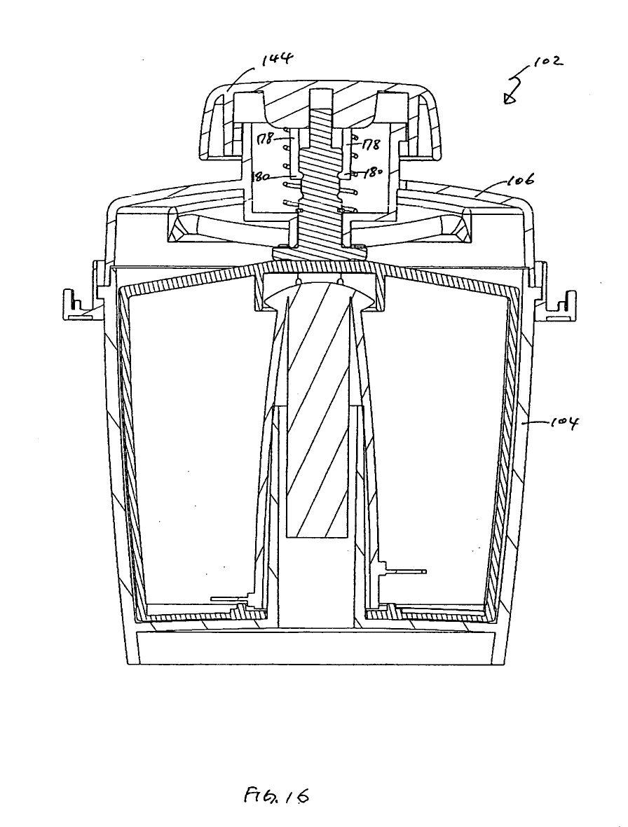

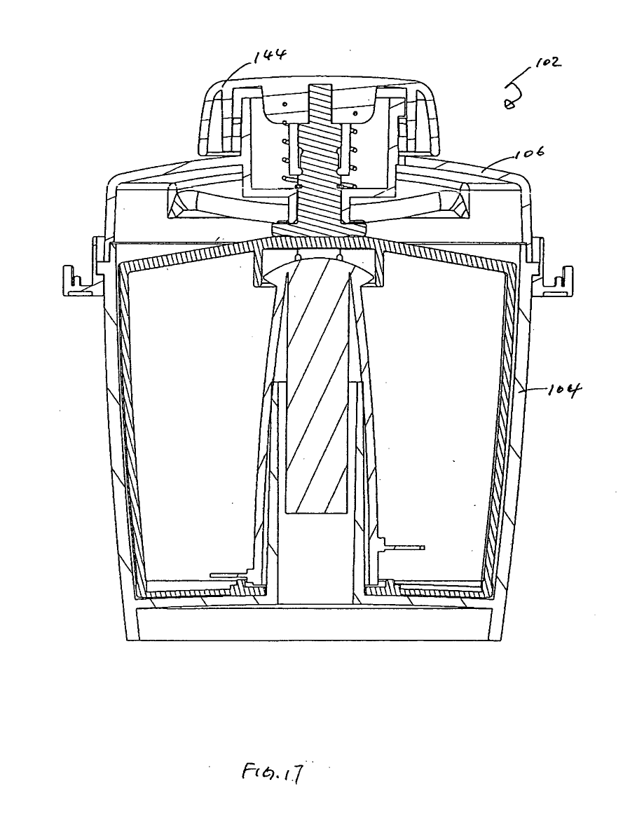

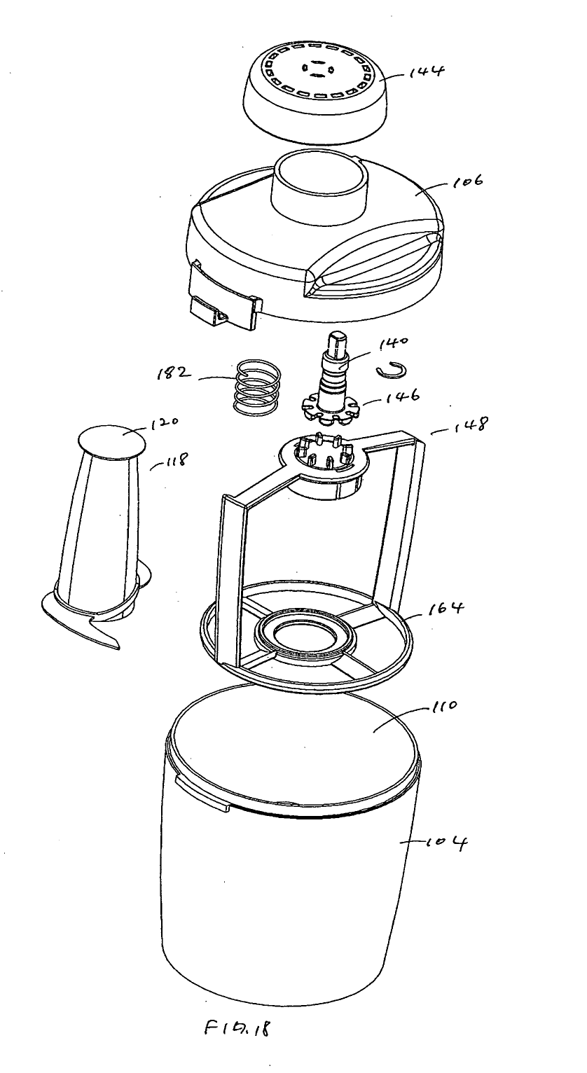

FIGS. 9 to 19 illustrate a second embodiment of a container 102 of a food processor in accordance with the present invention. Similar to the container 2 in the first embodiment, it likewise comprises a main body 104 with an upper opening 110 closable by a lid 106, a pair of handles 112, 114 adjacent to the opening 110 and arranged at opposite sides thereof, a first blade means 118 for chopping food therein and a second blade means 148 for scraping off foodstuff adhered on sidewall in the container 102. One main difference from the container 2 of the first embodiment is that in the container 102 the second blade means 148 is operable by a different mechanism. FIG. 13 illustrates a cross section view of the container 102 taken at an off-center position and at line D-D′ in FIG. 12a. As shown in FIG. 13, the mechanism includes a relatively large turnable knob 144 to fit the grip of the palm of a user. This knob 144 basically replaces the rotatable knob portion 44 and the arm portion 42. FIGS. 14 and 16 illustrate cross section views of the container 102 but taken at the center thereof (see FIGS. 12a and 12c) (at lines E-E′ and G-G′). In FIG. 16, it is shown that a pair of legs 178 with a hook 180 at the lower end thereof is downwardly extended from the underside of the knob 144. This pair of legs 178 serves to retain the knob 144 in position. A spindle 140 similar to the spindle 40 is vertically arranged and runs through the center of the lid 106. The upper end of the spindle 140 has a cross section which is non-circular in cross section, and it engages with a corresponding recess on the underside of the knob 144 such that as the knob 144 is turned the spindle 140 is also caused to turned accordingly. The lower end of the spindle 140 is provided with a cam means 146 engageable with and for rotating the second blade means 148. A compression spring 182 is arranged between the knob 144 and the lid 106 and biases the knob 144 to an upper, or locked, position. When the knob 144 is disposed in the upper position (as in FIGS. 11 and 16), the knob 140 and also the second blade means 148 are locked in position and not movable. When the knob 144 is disposed to a lower position and is turned to rotate, the spindle 140 and thus the second blade means 148 are also caused to rotate, thus scrapping off any foodstuff adhered on the sidewall in the container 102 in a similar fashion as with the first embodiment. With the provision of the spring 182, the knob 144 is biased to the upper locked position when not in use.

It should be understood that the above only illustrates examples whereby the present invention may be carried out, and that various modifications and/or verifications may be made thereto without departing from the sprit of the invention. For instance, the circular base 64, 164 member may be provided with an upstanding circumferential flange in order to further discourage accidental access to the blade members 30, 32, 130, 132. The second blade means 48, 148 may be modified to operate automatically to rotate periodically or simultaneously with the first blade means 18, 118. The container 2, 102 may adopt an inverted-conical shape.

1. A food processing apparatus comprising a container defining a cavity and adapted to contain food to be treated, a first blade member rotatable to mix and/or cut food in said container, and a second blade member rotatable to remove food adhered on a sidewall in said container.

2. An apparatus as claimed in claim 1 wherein said container has a transverse cross section in circular shape.

3. An apparatus as claimed in claim 1 wherein said first blade member and said second blade member are fixedly connected together.

4. An apparatus as claimed in claim 1 wherein said first blade member and said second blade member are releasably connected together.

5. An apparatus as claimed in claim 1 wherein said second blade member is relatively thin and is elongate in shape.

6. An apparatus as claimed in claim 1 wherein said second blade member is arranged vertically adjacent said sidewall and adapted to direct foodstuff adhered thereon to said first blade member.

7. An apparatus as claimed in claim 1 comprising two said second blade members arranged on opposite sides in said container.

8. An apparatus as claimed in claim 1 wherein said second blade member is manually operable.

9. An apparatus as claimed in claim 1 wherein said second blade member is electrically operated.

10. An apparatus as claimed in claim 1 wherein said second blade member is operable by a rotatable handle or knob.

11. An apparatus as claimed in claim 1 comprising a base member connected to said second blade member and arranged at the bottom in said container.

12. An apparatus as claimed in claim 11 wherein said base member is sufficiently thick and/or adapted to prevent or minimize access to the cutting edge of said blade member.

13. An apparatus as claimed in claim 1 wherein both said first blade member and said second blade member are rotatable simultaneously.

14. An apparatus as claimed in claim 1 wherein both said first blade member and said second blade member are rotatable independently.

15. An apparatus as claimed in claim 1 wherein said first blade member and said second blade member are rotatable in opposite directions.

16. An apparatus as claimed in claim 1 wherein said apparatus is a food processor, a food chopper or a food blender.
